(19) United States
(12) Patent Application Publication
(10) Pub. No.: US 2024/0247450 A1
(43) Pub. Date: Jul. 25, 2024

(54) Road repair systems

(71) Applicant: Thermal Road Repairs Limited, Crewe (GB)

(72) Inventors: Henry Aidan Conway, Hale (GB); Mark Richard Jones, Crewe (GB)

(21) Appl. No.: 18/416,501

(22) Filed: Jan. 18, 2024

(30) Foreign Application Priority Data
Jan. 19, 2023 (GB) 2300782.6

(51) Int. Cl. E01C 23/14

(52) U.S. Cl. CPC E01C 23/14

(57) ABSTRACT

Apparatus and associated methods for heating a road surface for repair, the apparatus comprising a combustion chamber containing a plate adapted to radiate infra-red radiation towards the road surface, the plate having a first plurality of through-holes formed in it which face towards the road surface, and, located a predetermined distance between the plate and the road surface, a radiant screen having a second plurality of through-holes in it and adapted to absorb infra-red radiation radiated from the plate and heat from combustion gases discharged from the first plurality of through-holes and to radiate heat in addition to that emitted from the plate towards the road surface.

### FIELD OF THE INVENTION

The present invention relates to apparatus and methods for the repair of roads and in particular to systems useful in the repair of asphalt roads.

### BACKGROUND ART

Asphalt is commonly used in road surfacing. Asphalt deteriorates because of oxidation and the constant pounding of traffic, but it is the joints from old repairs that are the most prone to wear and damage over time due to weathering and water ingress, and the asphalt in these and adjacent areas breaks up the seal asphalt. Considerable sums of money are spent each year on routine maintenance and repair of carriages and footways, and the utility companies also spend large sums making effective repairs after their excavations, Furthermore, roads are generally deteriorating.

Bituminous wearing courses such as asphalt are generally composed of about 94% aggregate (gravel or sand) and about 6% bitumen binder. The bitumen binder is composed of hydrocarbons and has ionic properties, which serve to bind the sand and gravel particles together.

Wearing courses deteriorate through oxidation of the bituminous binder. The oxidation process reduces the ionic properties of the bitumen, which in turn leads to release of the aggregate. The oxidised binder loses its flexibility and the surface shrinks and cracks. The effects of traffic and weather (temperature changes and moisture) speed up this process. After general release of material larger flaws appear which eventually turn into potholes.

The oxidisation process accelerates other damage to the wearing course and failure of joints especially from conventional reinstatements, around ironwork and on trenchwork, The traditional method for the repair of damaged or aged asphalt and tarmacadam-wearing courses comprises the total removal of an area and its replacement with new asphalt. The damaged area and its surrounds may be removed by using noisy pneumatic or hydraulic hand held or machine mounted breakers. In this traditional method it is necessary to use expensive and very noisy diamond saws to pre-cut the area to minimise additional S damage and to form a face to bond in the replacement material. The areas may also be removed by more modern methods known as cold planning that pulverizes the damaged asphalt.

The area is then filled with new material that then needs to be compacted and sealed with overbanding or jointing sealant. The removed asphalt is then transported away for disposal that is normally for land-fill due to the limitations of current re-cycling systems.

These conventional methods are not ideal in respect of costs, safety, t5 environment, sustainability and durability.

More recently Hot In-Place Recycling (HIR) techniques have been developed for the effective repair of potholes, cracks and sunken utility cuts in asphalt surfaces using an infrared heating process. With the surface heated and raked it is then combined with a rejuvenation liquid that will recycle the existing embrittled asphalt. This enables a substantial reduction in repair costs, The rejuvenating liquid for use in the method comprises an emulsifier, a heavy paraffinic distillate solvent extract, a heavy naphthenic distillate solvent extract, a naturally occurring mineral asphalt and water.

The infrared HIR method comprises: heating the damaged area with an infrared heating device; adding new material if required; raking together; applying a liquid that rejuvenates the original bitumen; and compacting the new combined material. The HIR method can also include applying a topcoat of liquid to the repaired area that seals and binds the repair, or applying a fine aggregate to provide skid resistance.

The general principles of construction and operation of an infrared road heater apparatus are shown in GB2506097; the present invention is intended to improve the efficiency of apparatus for heating a road surface for repair whilst at the same time reducing its adverse environmental impact, and to provide improved methods of heating an asphalt road surface which in turn facilitates the repair of damaged sections such as potholes in an asphalt road surface.

### SUMMARY OF THE INVENTION

The present invention therefore provides an apparatus for heating a road surface for repair, the apparatus comprising a combustion chamber containing a plate adapted to radiate infra-red radiation towards the road surface, the plate having a first plurality of through-holes formed in it which face towards the road surface, and, located a predetermined distance between the plate and the road surface, a radiant screen having a second plurality of through-holes in it and adapted to absorb infra-red radiation radiated from the plate and heat from combustion gases discharged from the first plurality of through-holes and to radiate heat in addition to that emitted from the plate towards the road surface.

The provision of such a radiant screen between the plate and the road surface, we have found, increases the effective heat output of the apparatus to the road surface by approximately 20-30%; alternatively it allows a reduction in the fuel provided to the combustion chamber whilst maintaining a similar heat output to the road surface as an apparatus without such a screen. The combustion gas may be methane, which can be harvested from animal or food waste; the increased heat achievable with apparatus in accordance with the invention permits approximately 99.9% complete combustion of methane gas, making such apparatus more environmentally-favourable than conventional road heating apparatus.

Preferably the first and second plurality of holes are both arranged in regular arrays, or patterns and the two arrays are substantially aligned, either so that the holes are vertically aligned above the road surface so that the combustion gases can flow freely through both the plate and the radiant screen towards the road surface, or so that the holes in the plate are above the solid parts of the radiant screen and the solid parts of the plate are above the holes in the radiant screen, so that the infra-red radiating surface of the plate is visible to the road surface and the solid parts of the radiant screen are heated by both contact with the hot gases from the combustion chamber and the infra-red radiation from the plate, thus heating the radiant plate more thoroughly so as to radiate more heat towards the road surface. It will be understood that such arrangements can be varied, as can the relative sizes of the holes in the plate and the holes in the radiant screen, to suit different applications and/or types of road surface materials.

The through-holes of the second plurality may be greater in size than the through-holes of the first plurality; this allows more of the radiating surface of the plate to be visible to the road surface through the second plurality of holes, so maximising the heat received by the road surface. Preferably the radiant screen comprises a metal mesh screen, more preferably a screen formed of two layers of metal mesh; such screens may be formed of stainless steel, which is an effective infra-red radiator, can operate at elevated temperatures without deforming, or sagging (which would have an adverse effect on the uniformity of the heating temperatures available), and can be easily manufactured. As is known, the plate may form a burner membrane medium that comprises a sintered metal fibre plate; regularly positioned through-holes in the sintered metal fibre plate enable the formation of a uniform heating temperature across the whole of the burner membrane. This uniformity ensures that a target region of asphalt road surface is subject to uniform infra-red penetration, thereby avoiding the carbonizing or ‘burning’ of parts of the target region that might otherwise occur.

The present invention is described in the context where most road surfaces are substantially horizontal; however, not all road surfaces are horizontal. Hereinafter the use of terms such as vertical and horizontal should be construed as being substantially perpendicular or substantially parallel to the road surface which the apparatus is being used to heat/repair. Preferably the predetermined distance is one which locates the radiant screen a vertical distance from the plate which is approximately one third of the vertical distance between the plate and the road surface. We have found that such an arrangement optimises the additional heat effect provided by the radiant screen.

The apparatus may comprise two or more combustion chambers, each having an associated plate and a radiant screen. There may be an enclosure extending around and generally above the two or more combustion chambers, plates and screens and having a skirt extending in a vertical direction towards the road surface and extending in a horizontal direction circumferentially around the combustion chambers, the enclosure being configured so as to conduct hot gases from the combustion chamber and from the road surface thereunder upwardly and around the combustion chambers.

Two or more combustion chambers may be arranged in a horizontal array, and the skirt may be configured so as to isolate adjacent combustion chambers from each other, and to conduct hot gases upwardly from each combustion chamber and the road surface thereunder separately from hot gases from an adjacent combustion chamber and from the road surface thereunder.

The use of two or more combustion chambers in a single apparatus allows greater flexibility in methods of applying heat in cycles of varying temperature to a road surface, particularly where the apparatus is mounted to a carriage so that heating of a significant length of road surface may be carried out in a continuous process as the carriage moves forwardly. Such continuous repair processes are often used in the repair of roads, see GB2528905, for example), and are desirable because they allow road repairs to be carried out quickly and without closing the road entirely and/or for long periods. The provision of an enclosure skirting a single combustion chamber is known, however where there are multiple combustion chambers the provision of a skirt which isolates adjacent, or individual combustion chambers not only allows the combustion chambers to be used separately, or selectively, but also allows different hot gas mixtures arising from different road surfaces and/or road surface temperatures to be treated, for example to remove elements which are harmful to the environment (e.g. particulates, soot, harmful gases) before the separate hot gases are allowed to mix and/or exit to the ambient atmosphere. The enclosure may be configured so that the hot gases are conducted vertically away from the combustion chambers and through a fan mechanism to generate electricity which can be used to power the apparatus. In addition, the enclosure may be configured to conduct hot gases around the exterior walls of the combustion chambers so as to transfer heat thereto and improve the efficiency of the combustion within.

There may be a heater controller (such as a suitably programmed processor or computer) adapted to control a ratio of gas and air in an air/gas mixture to be burnt in the combustion chamber in order to vary the level of infra-red heat emitted by the apparatus over time in a programmed heat cycle, whereby the level of infra-red heat emitted varies within a range provided by the heater controller.

There may be temperature sensing means positionable in use in close proximity to the road surface(s) being heated, the temperature sensing means being adapted to communicate the temperature of the heated road surface(s) to the heater controller. The temperature sensing means may communicate the temperature in the proximity of the heated surface heated back to the heater controller, thereby enabling the heater controller to vary the level of infra-red heat emitted by the apparatus accordingly. In this way the process of preventing the asphalt from overheating is carried out automatically. The heater controller may vary the level of infra-red heat emitted by the apparatus by controlling the ratio of gas and air in the air/gas mixture being burnt in the combustion chamber. Alternatively, or additionally, the heater controller may vary the level of infra-red heat emitted by the apparatus by controlling the rate at which an air/gas mixture is burnt by the heater.

There may be an air filter that cleans the air entering the or each combustion chamber. In this way it is possible to filter the dirty or contaminated air entering the combustion chamber, thereby improving the efficiency and performance of the apparatus. Filtering the air also helps to ensure that a constant temperature can be maintained at the burner membrane by removing contaminants that may require more heat to bum them. There may be height adjustment means that, in use, facilitate the movement of the apparatus relative to a surface that is to be heated. In this way the apparatus can be moved towards and away from the road surface as necessary. This is considered particularly important when dealing with areas of road surface that have a variable or uneven surface. This helps to avoid the overheating and burning of the target region of asphalt road surface. The height adjustment means may be hydraulically operated. In this way a single operator can easily and safely adjust the height of the apparatus relative to the road surface.

The present invention also provides a method of heating an asphalt road surface with an apparatus comprising at least one combustion chamber containing a plate adapted to radiate infra-red radiation towards the road surface, the plate having a first plurality of through-holes formed in it which face towards the road surface, and, located a predetermined distance between the plate and the road surface, a radiant screen having a second plurality of through-holes in it and adapted to absorb infra-red radiation radiated from the plate and heat from combustion gases discharged from the first plurality of through-holes and to radiate heat in addition to that emitted from the plate towards the road surface, the method comprising positioning the apparatus over a target region of road surface that is to be heated, and controlling a ratio of combustible gas to air in an air/gas mixture burnt in the at least one combustion chamber to subject the target region to levels of infra-red heat that vary over time in accordance with a heat wave cycle.

Varying the infra-red heat levels provides improved heat penetration of the target region of asphalt road surface by subjecting the road surface to infra-red energy of high and low wavelengths. Low energy wavelengths of infra-red penetrate further into the asphalt than high energy wavelengths and thus these methods can ensure that not just the top layer of the target region is heated. The level of heat given off by the apparatus may additionally or alternatively, be varied by controlling the rate at which an air/gas mixture is burnt by the apparatus.

Where the apparatus comprises at least two combustion chambers arranged in a line, the method may further comprise moving the apparatus in the direction of the line at a predetermined velocity while controlling the ratio of combustible gas to air in the air/gas mixtures burnt in the at least two combustion chambers so as to subject the target regions to successive levels of infra-red heat that vary over time in accordance with the heat wave cycle. Such an arrangement facilitates the heating and repair of the road surface in a continuous process as the apparatus moves forwardly.

Preferably the level of infra-red heat emitted by the heater may be varied within in a heating range in accordance with a heat wave cycle that is shaped like a curved ‘W’. In other words, the temperature output of the heater starts our high then it gradually falls before it rises again. This temperature fluctuation continues over time until the heating process is terminated. The heating range of the apparatus is preferably maintained between 150° and 400° C., and/or the infra-red levels may be adjusted to ensure that the temperature at or in the proximity of the target region stays with the temperature range of 80° and 200° C.; in this way the target region of asphalt is constantly heated but not over heated (above 200° C. asphalt can burn and become carbonized). The temperature at or in close proximity to the target region(s) may be measured, and the levels of infra-red heat emitted by the apparatus adjusted accordingly; in this way the heat emitted by the heater can be varied in such a way to take account of the ambient temperature at the target region surface.

### BRIEF DESCRIPTION OF THE DRAWINGS

The invention will now be described by way of example and with reference to the accompanying figures, in which;

FIG. 1 is a schematic side elevation of an apparatus in accordance with the invention, and

FIG. 2 is a schematic illustration showing how the heat penetration of a target region of road surface is varied over time.

### DETAILED DESCRIPTION OF THE EMBODIMENTS

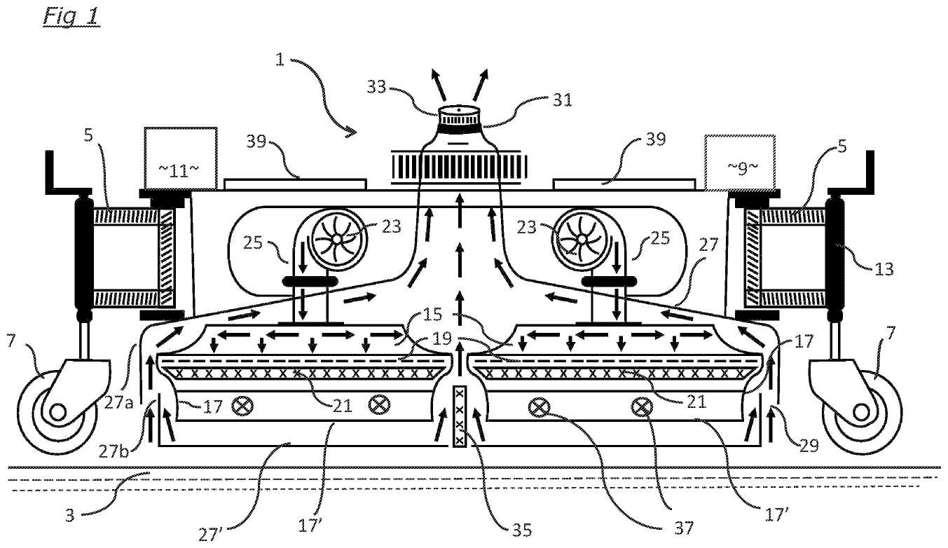

FIG. 1 shows a cross-sectional side view an apparatus 1 for heating a road surface 3 for repair. Straight arrows in the drawing show the general direction of gas flows within the apparatus. The apparatus has a rigid chassis 5 which has wheels 7 to allow the apparatus to be moved (typically there are four wheels, with one at each corner of the apparatus 1, but there may be more wheels, particularly where the apparatus includes a larger number of separate combustion chambers); a motor drive mechanism (such as electrical hub motors, not shown) may be provided to drive the apparatus in a forward or rearward direction (leftwards or rightwards, respectively, in the drawing), powered by a battery 9. A programmable controller 11 (e.g. a microprocessor or tablet computer, with a keyboard for an operator to input programming data) controls the drive mechanism, as well as other aspects of the apparatus 1, as will be described.

Each wheel is provided with a height adjustment mechanism 13 to allow the apparatus 1 to be moved vertically towards and away from the road surface 3; a manually-operated screw-type height adjustment mechanism 13 is shown, but this mechanism may be hydraulic. The mechanism 13 allows the distance that the apparatus is positioned above the target region of asphalt road surface that is being heated to be varied. In this way the operator can further vary the heating effect on a target region, not least in situations where the target region is particularly uneven. Also, the apparatus can be raised away from the floor whilst the apparatus 1 is being moved from one location to another. in this way it is possible to avoid any components of the apparatus being damaged on uneven surfaces.

The apparatus 1 has two combustion chambers 15, each of which has an outer body 17 enclosing a horizontal sintered metal fibre burner plate 19 perforated with an array of through holes and, below the burner plate 19, a horizontal radiant screen 21 formed of two layers of stainless steel mesh. The radiant screen 21 is aligned so as to be substantially parallel to the burner plate 19, and is located between the burner plate 19 and the road surface 3. The outer body 17 is open at its bottom edge 17′ facing the target region of road surface 3 to be heated. A mixer fan 23 mixes a combustible gas such as methane with ambient air and supplies this gas mixture via conduit 25 to the combustion chamber 15, where the mixture is ignited and burns, heating the burner plate 19 which radiates infra-red heat downwardly towards the road surface; hot combustion gases and infra-red heat from the burner plate 19 heat the radiant screen 21, which then radiates additional infra-red heat downwardly towards the road surface. In practice we have found that, where the burner plate is at a height of about 150-155 mm above a reasonably level asphalt road surface, the optimum location of the radiant screen is about 50-55 mm below the burner plate (or located below the burner plate approximately a third of the distance between the burner plate and the road surface). The mixer fan 23 is a rotating fan which is rotated to disburse and spread the air/gas mix more evenly throughout the combustion chamber 15. This in turn facilitates uniform heating across the entire surface of the burner plate 19 which is provided in the combustion chamber 15.

An enclosure 27 encloses the two combustion chambers 15 and acts as a thermal shield to protect nearby operators from the heat generated by the apparatus 1 in use, and also to control the flow of hot combustion gases. The enclosure 27 surrounds the combustion chambers 15 on all sides and above, but is open at its bottom edge 27′, nearest the road surface 3; the enclosure 27 comprises a fixed, upper part 27 and a movable, lower skirt 27b. The skirt 27b is movable in a vertical direction to allow the enclosure to close off as far as possible any gap between the lower edge of the enclosure 27′ and the road surface so that combustion gases and any gases emitted through the heating of the road surface are drawn upwardly from the road surface into the enclosure 27 in the direction shown by the arrows, rather than vented to the atmosphere. There is a small circumferential gap 29 between the upper part 27a and the skirt 27b to allow ambient air to enter the enclosure; this cools the hot combustion and other gases and helps to entrain any particulates. The hot gases rise generally upwardly to a turbine 31, causing it to rotate and charge the battery 9, and are then vented to atmosphere through a filter 33. A transverse skirt section 35 extends between the two sides of the skirt 27b (i.e. into the plane of the drawing), separating the outer bodies 17 of the two combustion chambers 15 and conducting hot gases from each separately and upwardly as sown by the arrows; this allows the combustion chambers to be operated independently of each other, and to generate different levels of infra-red heat directed at different areas of road surface 3.

Temperature sensors 37 are provided in the skirt 27b of each combustion chamber 15, for measuring the temperatures of the road surface 3 beneath the combustion burner 15 and of the temperature of the burner plate 19 and radiant screen 21. Temperature readings are communicated to the controller 11, which is powered by battery 9 and operatively connected to the hub motors to control the direction and speed of movement of the apparatus 1, the height adjustment mechanism 13 to control the vertical distance between the combustion chambers 15 and the road surface 3, the fan mixers 23 to control the air/gas ratio and the air/gas flow rate to each combustion chamber 15, and the means for adjusting the height of the skirt 27b. Solar panels 39 are provided on the exterior of the apparatus 1 and assist in charging the battery 9.

Varying the temperatures generated in the combustion chamber 15 by controlling the nature of the air/gas mixture reaching the chamber facilitates the creation of a variable heat wave cycle. This variable heat wave cycle is considered preferable to the constant ‘on’ mode of older style asphalt heaters, wherein the constant application of heat at maximum temperature fails to create sufficient long wave infrared that can penetrate deep into the surface. High temperatures produced by older heaters result primarily in short wave infrared that only heats the top surface of the road material, which can then lead to an overheating of the top surface whilst the lower surfaces remain under-heated. The apparatus of the present invention has the capability to constantly vary its temperature by controlling the air/gas mixture supplied to the combustion chamber. It is envisaged that heat wave cycle is preferably shaped like a curved W″ shape, although alternative wave patterns could be applied depending upon the composition of the asphalt target region. The heat wave cycle involves a fluctuation between a temperature high of about 400° C. and a temperature low of about 150° C. and everything in between in such a way that the heater provides a mixture of short and long wave infrared, which gives the required heat penetration.

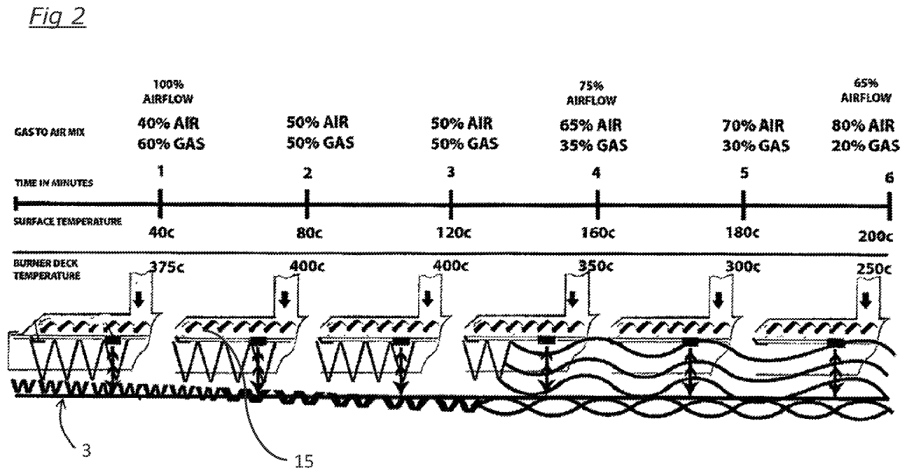

The variable heat wave cycle applied by the apparatus 1 of the present invention is described with reference to FIG. 2, which shows the heating process applied by a single combustion chamber 15 (or a single combustion chamber of a multiple combustion chamber apparatus) to illustrate the heating of a target region of road surface 3 over time. The heating process in FIG. 2 commences with an air/gas mixture of 40:60 being supplied to one combustion chamber 15 at the maximum rate achievable by the mixer fans 23. The air/gas mixture entering the combustion chamber 15 is ignited by a glow plug ignition means and the generation of heat begins. In a short time the burner plate 19 reaches a temperature of 375° C., whereas the temperature of the asphalt 3 is still relatively low at 40° C. After around two minutes the ratio of the air/gas mixture provided by the mixer fan 23 changes to 50:50 and the temperature of the burner membrane is now 200° C. The temperature of the asphalt 3 is now starting to rise to around 80° C., and the air/gas mixture is still being supplied to the combustion chamber 15 at the maximum rate achievable by the mixer fan 23. These conditions continue until around the four minute mark at which time the temperature is starting to approach the maximum preferred heating level of the asphalt (i.e. 200° C.). At around four minutes the ratio of the air/gas mixture is changed to 65:35 and the rate at which the mixture is supplied to the combustion chamber by the mixer fan is lowered. This serves to lower the temperature output of the burner plate 19 to around 350° C.

The temperature of the asphalt road surface 3 continues to rise under the heating effects of the apparatus and after around 5 minutes the air/gas mixture is varied again to 70:30, although the rate at which the mixture is supplied to the combustion chamber remains the same. This serves to further decrease the temperature output of the apparatus.

As the temperature output of the apparatus decreases, the rate at which the temperature of the asphalt rises slows, However, after 6 minutes the temperature output of the apparatus is further decreased by changing the air/gas mixture to 80:20. In addition the rate at which the mixture is supplied to the combustion chamber by the mixer fan 23 is further decreased to 65%.

It will be understood from FIG. 2 that, as the temperature output of the burner plate 19 decreases, the wavelength of the infra-red energy imparted upon the asphalt 3 changes overtime, This enables the penetration of infra-red energy beyond the top layer of the asphalt in to the lower layers, which gives a thorough heating in depth of the asphalt target region that is to be repaired.

Although not shown, it will be appreciated that the variation of the ratio of the air/gas mixture and the rate at which it is supplied to the combustion chamber can be reversed to return the heat output to the higher levels again, thus completing a cycle. The rate at which the output temperature of the heater is varied can be according to a programme that is optimized for a particular asphalt composition. In this way alternative heating programmes, with different heating cycles, can be developed on a case by case basis.

It will also be understood that, with two or more combustion chambers mounted lengthwise, as shown in FIG. 1, the controller can vary the height of the apparatus and hence of the combustion chambers above the road surface, and/or the speed of forward or rearward movement of the apparatus, and/or the air/gas mixture ratio and/or air/gas mixture flow rate in order to provide a heating cycle which is appropriate to the road surface and/or to the nature of the repair to be carried out, so that the asphalt can be heated for repair in a continuously-moving process. The effectiveness of a programmed variable heat cycle can be increased by the controller reacting to temperature readings collected by the asphalt temperature sensors 37, and the rate variation or the extent to which the burner temperature is varied can be adapted to ensure that the asphalt surface is not overheated and burnt.

It will of course be understood that many variations may be made to the above-described embodiment without departing from the scope of the present invention. For example, the apparatus may comprise an onboard electrical power battery and one or more solar panels, which are mounted on the apparatus and supply power to the battery. In this way the apparatus is made self-sufficient and does not need to be in range of and reliant on a host vehicle for its electrical power. There may be a drive motor attached to the wheels to facilitate the powered manoeuvring of the apparatus. In this way a single operator can easily and safely move the apparatus from one target region of asphalt road surface to another. The controller may be adapted to be programmed to apply a predetermined heat cycle by an operator next to the apparatus, or it may be operated remotely, by wire or using a suitable telecommunications link such as WiFi or the like.

Where different variations or alternative arrangements are described above, it should be understood that embodiments of the invention may incorporate such variations and/or alternatives in any suitable combination. For example, apparatus in accordance with the invention may incorporate features described herein only in relation to the methods in accordance with the invention, and vice versa, where such incorporation is technically straightforward and requires no inventive skill.

1. Apparatus for heating a road surface for repair, the apparatus comprising a combustion chamber containing a plate adapted to radiate infra-red radiation towards the road surface, the plate having a first plurality of through-holes formed in it which face towards the road surface, and, located a predetermined distance between the plate and the road surface, a radiant screen having a second plurality of through-holes in it and adapted to absorb infra-red radiation radiated from the plate and heat from combustion gases discharged from the first plurality of through-holes and to radiate heat in addition to that emitted from the plate towards the road surface.

2. The apparatus according to claim 1 in which the first and second plurality of holes are both arranged in regular arrays, and the two arrays are substantially aligned.

3. The apparatus as claimed in claim 1 in which the through-holes of the second plurality are greater in size than the through-holes of the first plurality.

4. The apparatus according to claim 1 in which the radiant screen comprises a metal mesh.

5. The apparatus according to claim 4 in which the predetermined distance locates the radiant screen a distance from the plate which is approximately one third of the distance between the plate and the road surface.

6. The apparatus according to claim 1 comprising two or more combustion chambers, each having an associated plate and a radiant screen, and an enclosure extending around and generally above the two or more combustion chambers, plates and screens and having a skirt extending in a vertical direction towards the road surface and extending in a horizontal direction circumferentially around the combustion chambers, the enclosure being so as to conduct hot gases from the combustion chamber and from the road surface thereunder upwardly and around the combustion chambers.

7. The apparatus according to claim 6 in which the two or more combustion chambers are arranged in a horizontal array, and the skirt is configured so as to isolate adjacent combustion chambers from each other, and to conduct hot gases upwardly from each combustion chamber and the road surface thereunder separately from hot gases from an adjacent combustion chamber and from the road surface thereunder.

8. The apparatus according to claim 1 comprising a heater controller adapted to control a ratio of gas and air in an air/gas mixture to be burnt in the combustion chamber in order to vary the level of infra-red heat emitted by the apparatus over time in a programmed heat cycle, whereby the level of infra-red heat emitted varies within a range provided by the heater controller.

9. The apparatus according to claim 8, further comprising temperature sensing means positionable in use in close proximity to the road surface being heated, the temperature sensing means being adapted to communicate the temperature in the vicinity of the heated road surface to the heater controller.

10. A method of heating an asphalt road surface with an apparatus comprising at least one combustion chamber containing a plate adapted to radiate infra-red radiation towards the road surface, the plate having a first plurality of through-holes formed in it which face towards the road surface, and, located a predetermined distance between the plate and the road surface, a radiant screen having a second plurality of through-holes in it and adapted to absorb infra-red radiation radiated from the plate and heat from combustion gases discharged from the first plurality of through-holes and to radiate heat in addition to that emitted from the plate towards the road surface, the method comprising positioning the apparatus over a target region of road surface that is to be heated, and controlling a ratio of combustible gas to air in an air/gas mixture burnt in the at least one combustion chamber to subject the target region to levels of infra-red heat that vary over time in accordance with a heat wave cycle.

11. The method according to claim 10 in which the apparatus comprises at least two combustion chambers arranged in a line, the method further comprising moving the apparatus in the direction of the line at a predetermined velocity while controlling the ratio of combustible gas to air in the air/gas mixtures burnt in the at least two combustion chambers so as to subject the target regions to successive levels of infra-red heat that vary over time in accordance with the heat wave cycle.

12. The method according to claim 10 in which the heat wave cycle is shaped like a curved ‘W’.

13. The method according to claim 10 in which the heating range of the apparatus is maintained between 150° and 400° C.

14. The method according to claim 10, further comprising measuring the temperature at or in close proximity to the target region(s), and adjusting the levels of infra-red heat emitted by the apparatus accordingly.

15. The method according to claim 14 in which the infra-red heat levels are adjusted to maintain the temperature at or in close proximity to the target region(s) between 80° and 200° C.
